(19) United States
(12) Patent Application Publication
(10) Pub. No.: US 2005/0289332 A1
(43) Pub. Date: Dec. 29, 2005

(54) Platform boot speed

(76) Inventors: Michael A. Rothman, Puyallup, WA (US); Vincent J. Zimmer, Federal Way, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/875,742

(22) Filed: Jun. 23, 2004

(51) Int. Cl. G06F 15/177

(52) U.S. Cl. 713/1

(57) ABSTRACT

A method, system and article of manufacture to improve the boot speed of a platform. One or more non-blocking platform initializations are performed during a pre-boot phase of a computer system. One or more platform initializations are performed during the pre-boot phase, wherein the one or more platform initializations are performed concurrently in part with the one or more non-blocking platform initializations.

### BACKGROUND

1. Field

Embodiments of the invention relate to the field of computer systems and more specifically, but not exclusively, to improving platform boot speed.

2. Background Information

Generally, the pre-boot phase is defined as the period of time between computer system startup and the OS taking control of the system. At the startup of a typical computer system, firmware is loaded from non-volatile storage, such as Read-Only Memory (ROM), and executed. This firmware is sometimes referred to as the system Basic Input/Output System (BIOS). The firmware initializes the platform hardware, performs system tests, and prepares the system for the operating system (OS) to take control.

When the OS takes control of the system, the period commonly known as OS runtime begins. During OS runtime, the firmware may act as an interface between software and hardware components of a computer system. Such interface services include assisting with software interrupts.

As platforms include more and more devices, the time taken to initialize a system during the pre-boot phase becomes longer. In particular, as the size of system memory increases, the time to initialize the memory also increases.

Further, an increased pre-boot time is problematic considering that businesses today strive to maintain “5 9's” of availability. “5 9's” refers to an industry benchmark of keeping system availability 99.999% of the time. This translates to a system being down for only about 5 minutes per year. In the case of a system update requiring a reboot, minimizing the time used in booting a system is critical to maintaining “5 9's.”

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating one embodiment of an environment that supports improving platform boot speed in accordance with the teachings of the present invention.

FIG. 2A is a timeline illustrating one embodiment of a computer system not using a controller to improve platform boot speed in accordance with the teachings of the present invention.

FIG. 2B is a timeline illustrating one embodiment of a computer system using a controller to improve platform boot speed in accordance with the teachings of the present invention.

FIG. 3 is a flowchart illustrating one embodiment of the logic and operations to improve platform boot speed in accordance with the teachings of the present invention.

FIG. 4 is a flowchart illustrating one embodiment of the logic and operations to improve platform boot speed in accordance with the teachings of the present invention.

FIG. 5 is a flowchart illustrating one embodiment of the logic and operations to improve platform boot speed in accordance with the teachings of the present invention.

FIG. 6 is a block diagram illustrating one embodiment of a computer system to implement embodiments of the present invention.

### DETAILED DESCRIPTION

In the following description, numerous specific details are set forth to provide a thorough understanding of embodiments of the invention. One skilled in the relevant art will recognize, however, that embodiments of the invention can be practiced without one or more of the specific details, or with other methods, components, materials, etc. In other instances, well-known structures, materials, or operations are not shown or described in detail to avoid obscuring understanding of this description.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

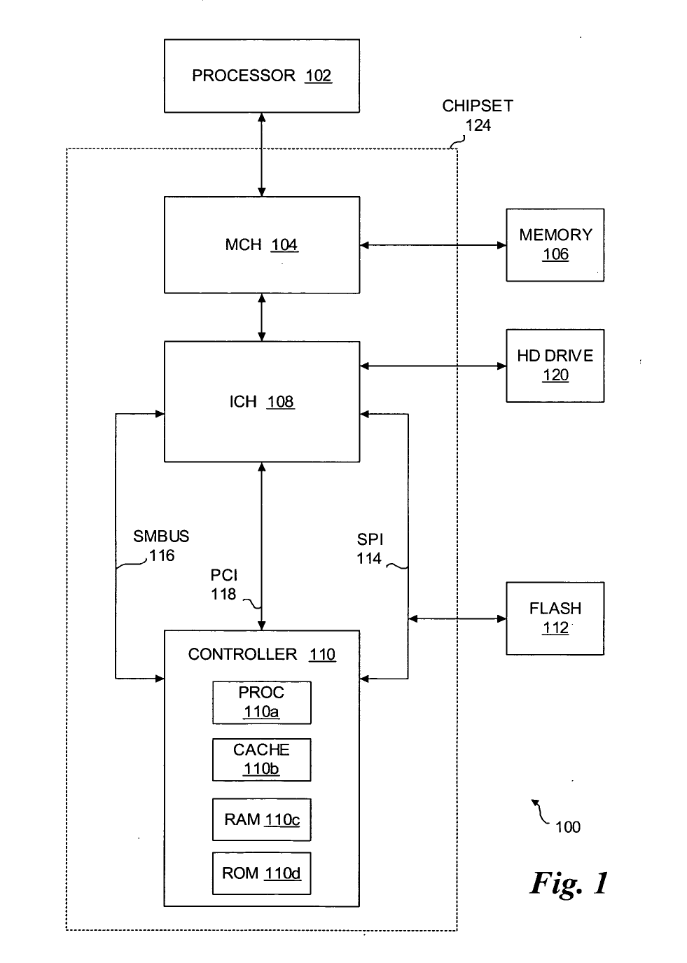

Referring to FIG. 1, one embodiment of a computer system 100 is shown. A chipset 124 includes an Input/Output (I/O) Controller Hub (ICH) 108 coupled to a Memory Controller Hub (MCH) 104. In one embodiment, ICH 108 serves as an I/O controller and MCH 104 serves as a memory controller.

Chipset 124 includes sockets (not shown) to couple a processor 102 and memory 106 to MCH 104. In one embodiment, processor 102 may include a central processing unit (CPU). A hard disk drive 120 is coupled to ICH 108 using an Advanced Technology Attachment (ATA) interface (see, American National Standards Institute (ANSI) Advanced Technology Attachment (ATA) specifications). Other storage devices, such as a floppy disk drive, an optical disk drive, or the like, may also be coupled to ICH 108 using an ATA interface.

Chipset 124 also includes a controller 110 coupled to ICH 108. In one embodiment, controller 110 may be coupled to ICH 108 via a System Management Bus (SMBUS) 116, a Peripheral Component Interface (PCI) bus 118, or a Serial Peripheral Interface (SPI) 114, or any combination thereof. PCI bus 118 may include PCI-X, PCI Express, or the like. In another embodiment, controller 110 is an integrated component of chipset 124.

In one embodiment, controller 110 may include a processor 110a for executing instructions provided to controller 110. In another embodiment, controller 110 may include a cache 110b, Random Access Memory (RAM) 110c, and Read-Only Memory (ROM) 110d operatively coupled to processor 110a by a bus (not shown). In one embodiment, ROM 110d has stored firmware instructions for execution during the pre-boot phase to support improving platform boot speed.

In one embodiment, controller 110 may include network resources for communicating over a network coupled to computer system 100. Controller 110 may communicate over such a network during the pre-boot phase and OS runtime. In one embodiment, controller 110 includes an Ethernet compatible connection.

In one embodiment, the network resources of controller 110 provide a manageability port for computer system 100. Such a manageability port may provide an out-of-band (OOB) communication path to access and manage computer system 100 over a network. In one embodiment, controller 110 and its network capabilities are not known to the user, but controller 110 is used in the background during pre-boot and runtime phases of computer system 100 by a system administrator or the like. In yet another embodiment, local controller 110 is part of an initiative to integrate intelligence into components to increase effectiveness of system management and applications.

In one embodiment, controller 110 is initialized at the beginning of startup of the computer system 100. In this particular embodiment, the firmware may initialize the controller 110 when processor 102 is initialized. In this way, the controller 110 is running and active before the firmware continues to more initializing tasks. Thus, the controller 110 may be available for executing instructions immediately after startup.

In another embodiment, controller 110 is active during a standby power state, such as a sleep state, of computer system 100. Thus, when computer system 100 is awakened, controller 110 is available immediately.

Since controller 110 is part of chipset 124, controller 110 has access to various platform devices during pre-boot. In one embodiment, since controller 110 has access to PCI bus 118, controller 110 may initialize peripheral devices during pre-boot (discussed further below). In another embodiment, controller 110 may interact with memory 106 during pre-boot because controller 110 is not walled off from accessing memory 106. In yet another embodiment, a direct connection between controller 110 and ICH 108 provides controller 110 with access to other system devices, such as hard disk drive 120.

Flash memory device 112 is coupled to SPI 114. In one embodiment, Flash memory device 112 includes a serial Flash memory device. It will be understood that in alternative embodiments, other non-volatile storage devices may be used in place of Flash memory device 112. In one embodiment, Flash memory device 112 has stored a system BIOS for computer system 100. In another embodiment, Flash memory device 112 has stored firmware instructions to improve platform boot speed as described herein. In other embodiments, other non-volatile storage devices, such as ROM, may be coupled to SPI 114 having stored firmware instructions.

Embodiments of Flash memory device 112 and embodiments of ROM 110d may store firmware instructions substantially in compliance with the Extensible Firmware Interface (EFI) (Extensible Firmware Interface Specification, Version 1.10, Dec. 1, 2002, available at http://developer.intel.com/technology/efi.) EFI enables firmware, in the form of firmware modules and drivers, to be loaded from a variety of different resources, including flash memory devices, option ROMs (Read-Only Memory), other storage devices, such as hard disks, CD-ROM (Compact Disk-Read Only Memory), or from one or more computer systems over a computer network. One embodiment of an implementation of the EFI specification is described in the Intel® Platform Innovation Framework for EFI Architecture Specification—Draft for Review, Version 0.9, Sep. 16, 2003 (available at www.intel.com/technology/framework). It will be understood that embodiments of the present invention are not limited to the “Framework” or implementations in compliance with the EFI specification.

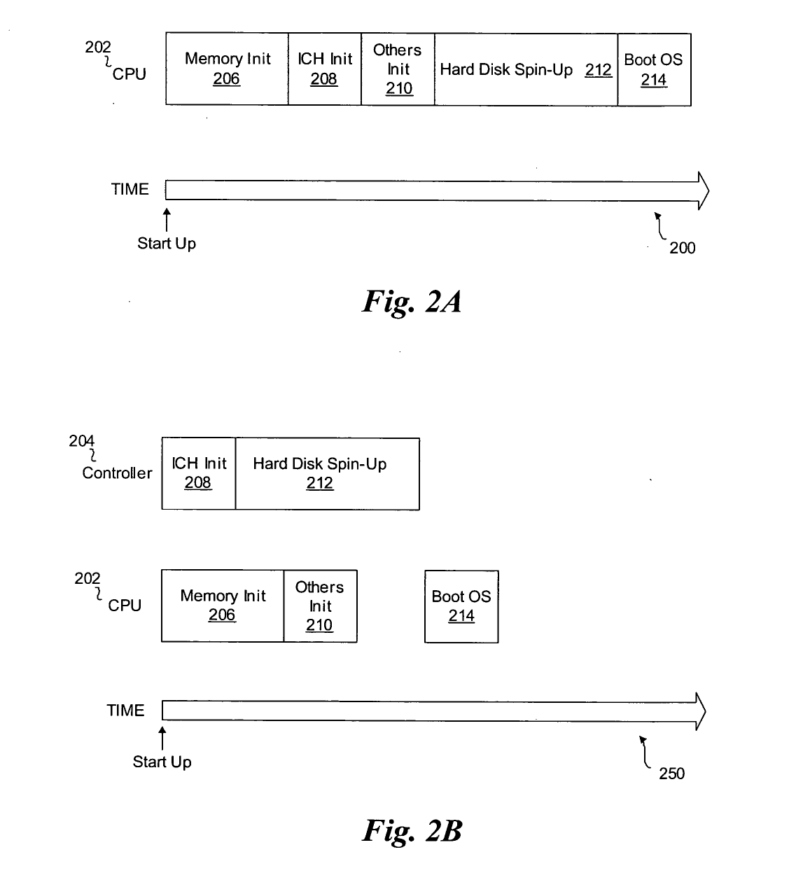

Referring to FIG. 2A, a timeline 200 shows the life cycle of one embodiment of a computer system not using a controller to improve platform boot speed. At startup, system BIOS firmware instructions stored in a non-volatile storage device, such as a Flash memory device 112, are loaded into memory and executed by CPU 202. During pre-boot, the platform is initialized to a state that the boot target, such as an operating system, may take control of the system.

In FIG. 2A, memory initialization 206 is performed. In one embodiment, memory initialization 206 includes initializing the MCH. This is followed by ICH initialization 208, and then initialization of other platform components 210. Other platform initializations may include PCI enumeration, initialization of add-in option-ROMs, or the like.

After other platform initializations 210, hard disk spin-up 212 is performed. The hard disk spin-up 212 includes bringing the disk speed up to operational level and performing other disk drive initializations to a point that read/write operations may be performed on the hard disk drive. After the hard disk spin-up 212, the OS boot 214 is performed.

In a typical pre-boot phase, hard disk spin-up 212 is one of the more time consuming events. For example, in a desktop platform configured with 1 Gigabyte (GB) of Double Data-Rate (DDR) 400 memory and a Western Digital® 1000 7200 Revolutions Per Minute (RPM) 100 GB hard disk drive, memory initialization 206 took approximately 3 seconds, while hard disk spin-up 212 took approximately 8 seconds.

Further, ICH initialization 208 and hard disk spin-up 212 may be considered non-blocking platform initializations. Non-blocking platform initializations include initialization events that a processor does not have to wait to be completed before the processor may perform another platform initialization. In the embodiment of FIG. 2, ICH initialization 208 and hard disk spin-up 212 are non-blocking platform initializations from the perspective of CPU 202. Some other platform initializations may be performed without having to wait for ICH initialization 208 and hard disk spin-up 212 to be completed.

Referring to FIG. 2B, a timeline 250 illustrating one embodiment of a computer system using a controller to improve platform boot speed is shown. In short, while a processor executes platform initializations, non-blocking platform initializations are performed by another processor of the computer system. It will be understood that embodiments of the invention are not limited to a CPU and a controller as shown in the embodiment of FIG. 2B; in other embodiments, pre-boot tasks may be conducted in parallel by two processors of the computer system, as described herein.

In the embodiment of FIG. 2B, ICH initialization 208 and hard disk spin-up 212 are performed by controller 204. As controller 204 conducts the ICH initialization 208 and disk spin-up 212, CPU 202 may perform the memory initialization 206 and other platform initializations 210 in parallel. Thus, controller 204 may act as a pre-boot co-processor. Once initialization events have been completed by CPU 202 and controller 204, the OS boot 214 may be initiated. Thus, the time needed for the pre-boot phase in the embodiment of FIG. 2A has been reduced by using controller 204 to execute non-blocking platform initializations.

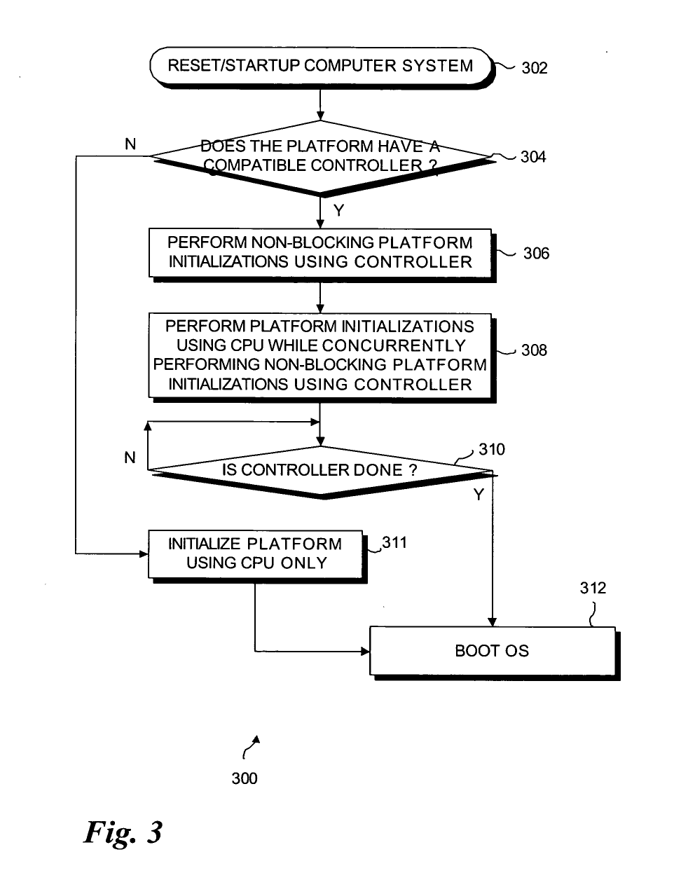

Turning to FIG. 3, flowchart 300 illustrates the logic and operations to improve platform boot speed in accordance with one embodiment of the present invention. Beginning in a block 302, a computer system is reset/started. In one embodiment, instructions stored in non-volatile storage are loaded. In one embodiment, the instructions may begin initializing the platform by conducting a Power-On Self-Test (POST) routine. In another embodiment, the computer system is awakened from a sleep state.

Proceeding to a decision block 304, the logic determines if the platform has a controller compatible for performing non-blocking platform initializations. In one embodiment, the CPU may check a status flag to determine if the controller is initialized and active. If the answer is no, then the logic proceeds to a block 311 to initialize the platform using only the CPU. After initializing the platform in block 311, the logic proceeds to a block 312 to boot the target OS.

If the answer to decision block 304 is yes, then the logic proceeds to a block 306 to perform one or more non-blocking platform initializations using the controller. In one embodiment, instructions loaded from a flash memory device indicate what non-blocking platform initializations are to be executed by the controller. In one embodiment, the controller performs all of the system's non-blocking platform initializations; while in another embodiment, the controller performs less than all of the system's non-blocking platform initializations.

While the controller performs non-blocking platform initializations, the logic proceeds to block 308 to perform one or more platform initializations using the CPU while concurrently performing one or more non-blocking platform initializations using the controller.

The logic then proceeds to a decision block 310 to determine if the controller has completed its pre-boot tasks. If the answer is no, then the logic loops through decision block 310 waiting for the controller to finish. If the answer to decision block 310 is yes, then the logic proceeds to block 312 to boot the OS. In some embodiments, the CPU may complete its pre-boot tasks before the controller, while in other embodiments, the controller may complete its pre-boot tasks before the CPU.

In one embodiment of decision block 310, the controller reports when it has finished, such as through a flag. In another embodiment, the controller waits to be queried before reporting it has completed performing its assigned non-blocking platform initializations.

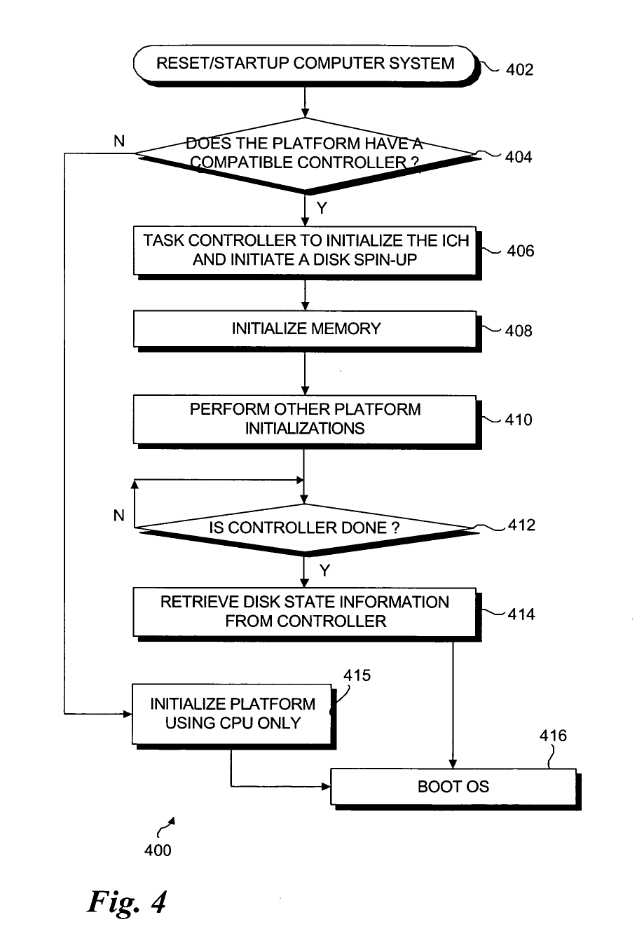

Referring to FIG. 4, flowchart 400 illustrates the logic and operations to improve platform boot speed in accordance with an embodiment of the present invention. The computer system is reset/started up, as shown in a block 402. Continuing to a decision block 404, the logic determines if the platform has a compatible controller. If the answer is no, then the logic proceeds to a block 415 to initialize the platform using only the CPU, and then to a block 416 to boot the OS.

If the answer to decision block 404 is yes, then the logic continues to a block 406 where the controller is tasked to begin initializing the ICH and to initiate a hard disk spin-up.

While the controller initializes the ICH and spins-up the hard disk, the logic continues to a block 408 to initialize memory of the computer system. Proceeding to a block 410, other platform initializations are performed.

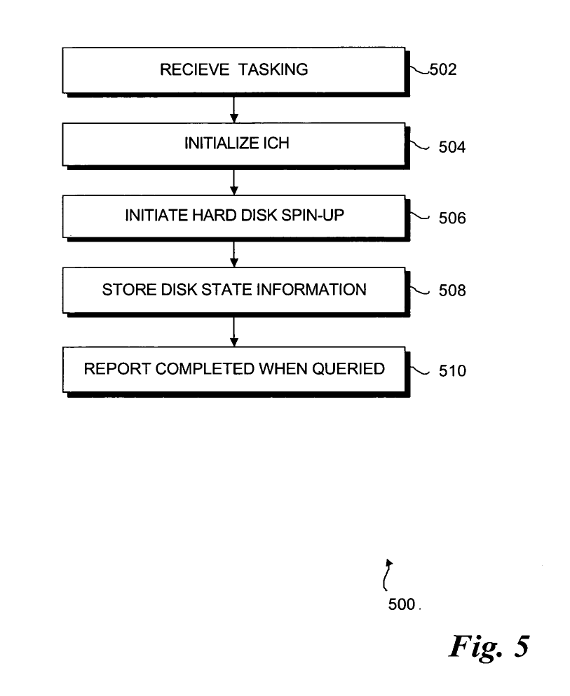

Turning to FIG. 5, flowchart 500 illustrates the logic and operations to improve platform boot speed in accordance with an embodiment of the present invention. Starting in a block 502, the controller receives tasking to start performing its assigned initializations. Proceeding to a block 504, the ICH is initialized by the controller. Continuing to a block 506, the controller initiates the spin-up of the hard disk drive.

Moving to a block 508, the controller stores disk state information. In one embodiment, the controller stores the information in onboard RAM. In another embodiment, the disk state information includes information used in autotyping the hard disk drive. In general, autotyping involves gathering drive configuration information to be used by the system BIOS. Such information includes which drives are connected to which channels, the geometry of a drive, and the drive's Logical Block Address (LBA) capability.

Referring back to FIG. 4, in a decision block 412, the logic determines if the controller has finished initializing the ICH and if the disk spin-up is complete. If the answer is no, the logic loops back to decision block 412. If the answer is yes, then the logic proceeds to a block 414 to retrieve the disk state information from the controller. In one embodiment, this information may be used in autotyping the drive. Proceeding to block 416, the OS is booted.

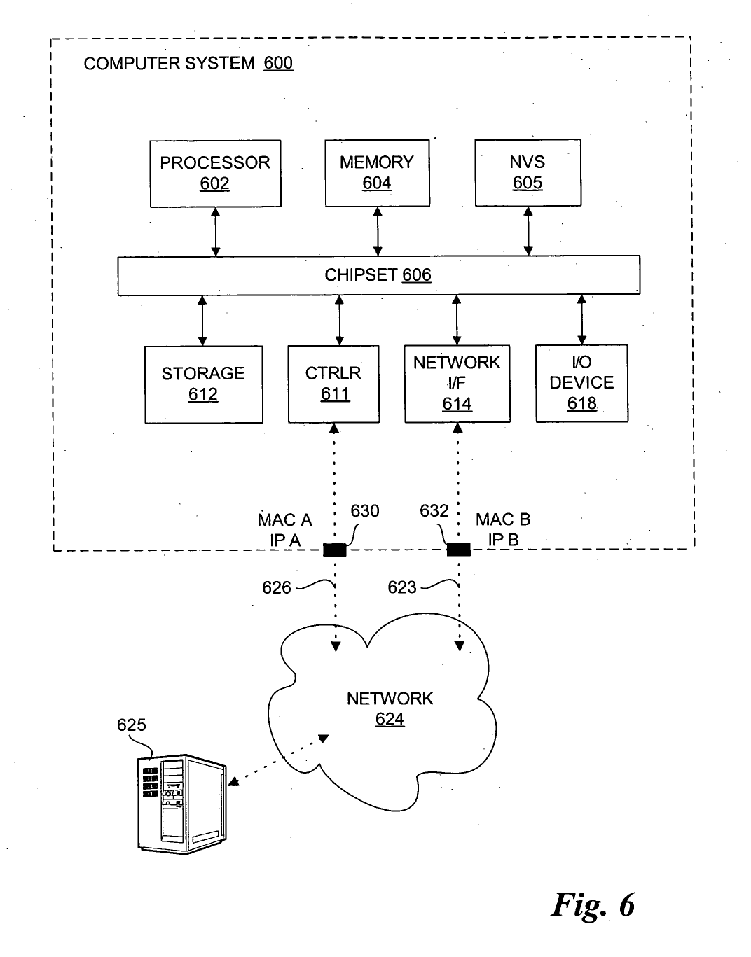

FIG. 6 is an illustration of one embodiment of an example computer system 600 on which embodiments of the present invention may be implemented. Computer system 600 includes a processor 602 and a memory 604 coupled to a chipset 606. Storage 612, non-volatile storage (NVS) 605, network interface 614, and Input/Output (I/O) device 618 may also be coupled to chipset 606. Embodiments of computer system 600 include, but are not limited to a desktop computer, a notebook computer, a server, a personal digital assistant, a network workstation, or the like.

Processor 602 may include, but is not limited to, an Intel Corporation x86, Pentium®, Xeon®, or Itanium® family processor, a Motorola family processor, or the like. In one embodiment, computer system 600 may include multiple processors. Memory 604 may include, but is not limited to, Dynamic Random Access Memory (DRAM), Static Random Access Memory (SRAM), Synchronized Dynamic Random Access Memory (SDRAM), Rambus Dynamic Random Access Memory (RDRAM), or the like.

Chipset 606 may include a Memory Controller Hub (MCH), an Input/Output Controller Hub (ICH), or the like. Chipset 606 may also include a Peripheral Component Interconnect (PCI) bus, a System Management Bus (SMBUS), a Low Pin Count (LPC) bus, a Serial Peripheral Interface (SPI) bus, or the like. I/O device 618 may include a keyboard, a mouse, a display, a printer, a scanner, or the like.

The computer system 600 may interface to external systems through network interface 614. Network interface 614 may include, but is not limited to, a modem, a network interface card (NIC), or other interfaces for coupling a computer system to other computer systems. A carrier wave signal 623 is received/transmitted by network interface 614. In the embodiment illustrated in FIG. 6, carrier wave signal 623 is used to interface computer system 600 with a network 624, such as a local area network (LAN), a wide area network (WAN), the Internet, or any combination thereof. In one embodiment, network 624 is further coupled to a target computer system 625 such that computer system 600 and target computer system 625 may communicate over network 624.

Computer system 600 may also include a controller 611 coupled to chipset 606. In one embodiment, controller 611 is integrated onto chipset 606. Controller 611 may perform non-blocking platform initializations to improve the boot speed of computer system 600, in accordance with embodiments described herein. Controller 611 may communicate with network 624 using a carrier wave signal 626.

In one embodiment, controller 611 is coupled to a port 630 having MAC address A and IP address A, and network interface 614 is coupled to a port 632 having MAC address B and IP address B. In this particular embodiment, computer system 600 is viewed by the network 624 as two distinct nodes.

The computer system 600 also includes NVS 605 on which firmware and/or data may be stored. Non-volatile storage devices include, but are not limited to, Read-Only Memory (ROM), Flash memory, Erasable Programmable Read Only Memory (EPROM), Electronically Erasable Programmable Read Only Memory (EEPROM), Non-Volatile Random Access Memory (NVRAM), or the like. Storage 612 includes, but is not limited to, a magnetic hard disk, a magnetic tape, an optical disk, or the like. It is appreciated that instructions executable by processor 602 may reside in storage 612, memory 604, NVS 605, controller 611, or may be transmitted or received via network interface 614.

For the purposes of the specification, a machine-accessible medium includes any mechanism that provides (i.e., stores and/or transmits) information in a form readable or accessible by a machine (e.g., a computer, network device, personal digital assistant, manufacturing tool, any device with a set of one or more processors, etc.). For example, a machine-accessible medium includes, but is not limited to, recordable/non-recordable media (e.g., read only memory (ROM), random access memory (RAM), magnetic disk storage media, optical storage media, a flash memory device, etc.). In addition, a machine-accessible medium may include propagated signals such as electrical, optical, acoustical or other form of propagated signals (e.g., carrier waves, infrared signals, digital signals, etc.).

It will be appreciated that in one embodiment, computer system 600 may execute operating system software. For example, one embodiment of the present invention utilizes Microsoft Windows® as the operating system for computer system 600. Other operating systems that may also be used with computer system 600 include, but are not limited to, the Apple Macintosh operating system, the Linux operating system, the Unix operating system, or the like.

The above description of illustrated embodiments of the invention, including what is described in the Abstract, is not intended to be exhaustive or to limit the embodiments to the precise forms disclosed. While specific embodiments of, and examples for, the invention are described herein for illustrative purposes, various equivalent modifications are possible, as those skilled in the relevant art will recognize. These modifications can be made to embodiments of the invention in light of the above detailed description.

The terms used in the following claims should not be construed to limit the invention to the specific embodiments disclosed in the specification. Rather, the following claims are to be construed in accordance with established doctrines of claim interpretation.

1. A method, comprising:
performing one or more non-blocking platform initializations during a pre-boot phase of a computer system; and
performing one or more platform initializations during the pre-boot phase, wherein the one or more platform initializations are performed concurrently in part with the one or more non-blocking platform initializations.

2. The method of claim 1 wherein the one or more non-blocking platform initializations include initializing an Input/Output (I/O) controller of the computer system.

3. The method of claim 1 wherein the one or more non-blocking platform initialization includes initiating a disk spin-up of a hard disk drive of the computer system.

4. The method of claim 3, further comprising storing disk state information of the hard disk drive.

5. The method of claim 4, further comprising retrieving the disk state information.

6. The method of claim 1 wherein the one or more platform initializations include initializing memory of the computer system.

7. The method of claim 1 wherein a first processor of the computer system executes the one or more non-blocking platform initializations and a second processor of the computer system executes the one or more platform initializations.

8. The method of claim 7 wherein the first processor is part of a controller and the second processor includes a central processing unit (CPU).

9. The method of claim 1 further comprising initiating the booting of an operating system on the computer system after the one or more non-blocking platform initializations and the one or more platform initializations are completed.

10. An article of manufacture comprising:
a machine-accessible medium including a plurality of instructions which when executed perform operations comprising:
performing one or more platform initializations by a first processor of a computer system during a pre-boot phase of the computer system;
tasking a second processor of the computer system to perform one or more non-blocking platform initializations during the pre-boot phase; and
performing the one or more non-blocking platform initializations by the second processor during the pre-boot phase, wherein the one or more platform initializations are performed concurrently in part with the one or more non-blocking platform initializations.

11. The article of manufacture of claim 10 wherein the one or more platform initializations includes initializing the memory and the one or more non-blocking platform initializations includes at least one of initializing an I/O controller of the computer system and initiating a disk spin-up of a hard disk drive of the computer system.

12. The article of manufacture of claim 11 wherein the I/O controller includes an Input/Output Controller Hub (ICH).

13. The article of manufacture of claim 10 wherein the first processor includes a central processing unit and the second processor is part of a controller.

14. The article of manufacture of claim 10 wherein the plurality of instructions include a system Basic Input/Output System (BIOS) for the computer system.

15. The article of manufacture of claim 10 wherein execution of the plurality of instructions further perform operations comprising storing disk state information of the hard disk drive.

16. The article of manufacture of claim 15 wherein execution of the plurality of instructions further perform operations comprising retrieving the disk state information.

17. The article of manufacture of claim 10 wherein the machine-accessible medium includes a flash memory device.

18. The article of manufacture of claim 10 wherein the plurality of instructions to operate substantially in accordance with an Extensible Firmware Interface (EFI) specification.

19. A computer system, comprising:
a processor;
at least one Synchronized Dynamic Random Access Memory (SDRAM) device operatively coupled to the processor;
a controller operatively coupled to the processor; and
a non-volatile storage device operatively coupled to the processor and to the controller, the non-volatile storage device including firmware instructions which when executed perform operations comprising:
performing one or more non-blocking platform initializations by the controller during a pre-boot phase of the computer system; and
performing one or more platform initializations by the processor during the pre-boot phase, wherein the one or more platform initializations are performed concurrently in part with the one or more non-blocking platform initializations.

20. The computer system of claim 19 wherein performing one or more platform initializations includes initializing the at least one SDRAM device.

21. The computer system of claim 19 wherein performing one or more platform non-blocking platform initializations includes initializing an Input/Output (I/O) controller operatively coupled to the processor.

22. The computer system of claim 21 wherein performing one or more platform non-blocking platform initializations includes initiating the spin-up of a hard disk drive operatively coupled to the I/O controller.

23. The computer system of claim 22 wherein the controller and the I/O controller are integrated components of a chipset of the computer system.

24. The computer system of claim 19 wherein the firmware instructions to operate substantially in compliance with an Extensible Firmware Interface (EFI) specification.
